(19) United States
(12) Patent Application Publication
(10) Pub. No.: US 2019/0204627 A1
(43) Pub. Date: Jul. 4, 2019

(54) VEHICLE, LIGHT CONTROL DEVICE AND LIGHT CONTROL METHOD THEREOF

(71) Applicant: BOE TECHNOLOGY GROUP CO., LTD., Beijing (CN)

(72) Inventors: Ming WANG, Beijing (CN); Guanghui LIU, Beijing (CN); Jun WANG, Beijing (CN)

(73) Assignees: BOE TECHNOLOGY GROUP CO., LTD., Beijing (CN); BOE TECHNOLOGY GROUP CO., LTD., Beijing (CN)

(21) Appl. No.: 15/779,469

(22) PCT Filed: Nov. 10, 2017
(86) PCT No.: PCT/CN2017/110442

§ 371 Date: May 25, 2018

(30) Foreign Application Priority Data
May 4, 2017 (CN) 201710309392.3

(51) Int. Cl. G02F 1/01; F21S 41/63; B60J 3/06

(52) U.S. Cl. CPC G02F 1/0136; B60J 3/06; F21S 41/63

(57) ABSTRACT

A light control device for a vehicle, includes a distance detector and at least one controllable polarizer. The distance detector detects the distance between a first vehicle in which the distance detector is located and an interference light source. The at least one controllable polarizer is configured to perform a polarization process on light to weaken the intensity of the light when the distance between the interference light source and the first vehicle is within a predetermined range; otherwise stop the polarization process on the light.

### CROSS-REFERENCE TO RELATED APPLICATION

This application claims priority to Chinese Patent Application No. 201710309392.3, filed on May 4, 2017, titled “VEHICLE, LIGHT CONTROL DEVICE AND LIGHT CONTROL METHOD THEREOF”, which is incorporated herein by reference in its entirety.

### TECHNICAL FIELD

The present disclosure relates to a technical field of optical treatment, and more particularly, to a vehicle, a light control device for a vehicle, and a light control method for a vehicle.

### BACKGROUND

With the rapid development of economy and society, an automobile has become an indispensable transportation tool in people's production and life. A large use of cars, buses and various freight vehicles has made a road traffic safety issue become a focus of the entire society.

When driving a car in a dim environment, drivers often use a high beam in order to ensure that a viewing field is broad and bright. However, when two vehicles are travelling towards each other, it often happens that one of or even both drivers cannot turn off the high beam in time. During these two vehicles meeting each other, strong light emitted from the high beam of one vehicle can easily lead to a visual blind spot to the driver of the other vehicle, so that the driver of the other vehicle cannot make a correct judgment on situations occurred on the road, and a traffic accident is easily to be caused.

### SUMMARY

An aspect of the disclosure provides a light control device for a vehicle. The light control device for a vehicle comprises a distance detector and at least one controllable polarizer, wherein, a signal output end of the distance detector is connected to a control end of each of the at least one controllable polarizer; the distance detector is configured to detect the distance between the first vehicle in which the distance detector is located and an interference light source; the at least one controllable polarizer is configured to perform a polarization process on light to weaken the intensity of the light when the distance between the interference light source and the first vehicle is within a predetermined range, and stop the polarization process on the light when the distance between the interference light source and the first vehicle is outside the predetermined range.

Optionally, the at least one controllable polarizer is located on a light-emitting surface of a headlight of the first vehicle.

Optionally, the at least one controllable polarizer is located on a windshield of the first vehicle.

Optionally, the at least one controllable polarizer includes two controllable polarizers, one of the two controllable polarizers is located on a light-emitting surface of a headlight of the first vehicle, and another is located on a windshield of the first vehicle; the polarization directions of the two controllable polarizers are different.

Optionally, each of the at least one controllable polarizer includes a controllable power supply, a first conductive layer, a second conductive layer, and a polarizing material layer located between the first conductive layer and the second conductive layer; output ends of the controllable power supply are connected to the first conductive layer and the second conductive layer, respectively; and the signal output end of the distance detector is connected to a control end of the controllable power supply.

Optionally, both the first conductive layer and the second conductive layer are made of an indium tin oxide material.

Optionally, the polarizing material layer includes an electro-optical crystal sublayer and an optical material sublayer sequentially disposed along a direction of light transmission.

Optionally, the interference light source includes a high beam located on a second vehicle travelling towards the first vehicle.

Another aspect of the disclosure further provides a vehicle. The vehicle includes the light control device provided by the above technical solutions.

Yet another aspect of the disclosure further provides a light control method for a vehicle, which is applied to the light control device provided by the above technical solutions. The light control method for a vehicle includes:

detecting, by a distance detector, the distance between a first vehicle in which the distance detector is located and an interference light source;

performing, by at least one controllable polarizer, a polarization process on light to weaken the intensity of the light when the distance between the interference light source and the first vehicle is within a predetermined range; stopping, by the at least one controllable polarizer, the polarization process on the light when the distance between the interference light source and the first vehicle is outside the predetermined range.

Optionally, the at least one controllable polarizer is located on the light-emitting surface of a headlight of the first vehicle; performing the polarization process on the light by the at least one controllable polarizer includes: performing the polarization process on the light emitted from the headlight of the first vehicle by the at least one controllable polarizer, to weaken the intensity of the light emitted from the headlight of the first vehicle;

stopping the polarization process on the light by the at least one controllable polarizer includes: stopping the polarization process on the light emitted from the headlight of the first vehicle by the at least one controllable polarizer.

Optionally, the at least one controllable polarizer is located on a windshield of the first vehicle, performing the polarization process on the light by the at least one controllable polarizer includes: performing the polarization process on the light emitted to the windshield of the first vehicle by the at least one controllable polarizer, to weaken the intensity of the light emitted to the windshield of the first vehicle;

stopping the polarization process on the light by the at least one controllable polarizer includes: stopping the polarization process on the light emitted to the windshield of the first vehicle by the at least one controllable polarizer.

Optionally, the at least one controllable polarizer includes two controllable polarizers, one of the two controllable polarizers is located on a light-emitting surface of a headlight of the first vehicle, and another controllable polarizer is located on a windshield of the first vehicle; the polarization directions of the two controllable polarizers are different;

performing the polarization process on the light by the two controllable polarizers includes: performing the polarization process on the light emitted from the headlight of the first vehicle by the controllable polarizer located on the light-emitting surface of the headlight of the first vehicle, to weaken the intensity of the light emitted from the headlight of the first vehicle; performing the polarization process on the light emitted to the windshield of the first vehicle by the controllable polarizer located on the windshield of the first vehicle, to weaken the intensity of the light emitted to the windshield of the first vehicle;

stopping the polarization process on the light by the two controllable polarizers includes: stopping the polarization process on the light emitted from the headlight of the first vehicle by the controllable polarizer located on the light-emitting surface of the headlight of the first vehicle; stopping the polarization process on the light emitted to the windshield of the first vehicle by the controllable polarizer located on the windshield of the first vehicle.

Optionally, each of the at least one controllable polarizer includes a controllable power supply, a first conductive layer, a second conductive layer, and a polarizing material layer between the first conductive layer and the second conductive layer; output ends of the controllable power supply are connected to the first conductive layer and the second conductive layer, respectively; and the signal output end of the distance detector is connected to a control end of the controllable power supply; the polarizing material layer includes an electro-optical crystal sublayer and an optical material sublayer sequentially disposed along the direction of light transmission;

performing the polarization process on the light by the at least one controllable polarizer includes:

for each controllable polarizer of the at least one controllable polarizer, applying voltages by its controllable power supply to its first conductive layer and its second conductive layer, so that its electro-optical crystal sublayer is in an electric field formed by the first conductive layer and the second conductive layer;

performing a birefringence process on light by the electro-optical crystal sublayer so that the light is divided into two linear polarized light beams with polarization directions perpendicular to each other;

when heading to its optical material sublayer, one of the two linear polarized light beams is totally reflected by the optical material sublayer, and another linear polarized light beam passes through the optical material sublayer, so that an emitted light with a single polarization direction is obtained.

Yet another aspect of the disclosure further provides a light control device for a vehicle, including a processor, a distance detector, and at least one controllable polarizer;

the distance detector is configured to detect the distance between a first vehicle in which the distance detector is located and an interference light source;

the processor is configured to determine whether the distance between the interference light source and the first vehicle is within a predetermined range when a detection result of the distance detector is received, and control the at least one controllable polarizer to perform a polarization process on light to weaken the intensity of the light in a case that the distance between the interference light source and the first vehicle is within the predetermined range, and control the at least one controllable polarizer to stop the polarization process on the light in a case that the distance between the interference light source and the first vehicle is outside the predetermined range.

Yet another aspect of the disclosure further provides a non-transitory computer readable storage medium on which computer instructions that are executed by a processor are stored, and the computer instructions are configured to perform the above light control method for a vehicle while the processor is running.

Yet another aspect of the disclosure further provides a computer program product. The computer program product includes instructions. When the instructions are running on a computer, the light control method for a vehicle described above is performed by the computer.

Yet another aspect of the disclosure further provides a computer program. When the computer program is loaded onto the processor and then executed by the processor, the light control method for a vehicle as described above is implemented.

### BRIEF DESCRIPTION OF THE DRAWINGS

The accompanying drawings shown here are used to provide further understanding of the disclosure and constitute a part of the description. The embodiments of the present disclosure and description thereof serve to explain the disclosure, but do not constitute a limitation to the disclosure. In the accompanying drawings:

FIG. 1 is a structural block diagram of a light control device of a vehicle provided by some embodiments of the present disclosure;

FIG. 2 is a flowchart of a light control method for a vehicle provided by some embodiments of the present disclosure;

FIG. 3 is a schematic diagram of a light control device for a vehicle in a first position of the vehicle provided by some embodiments of the present disclosure;

FIG. 4 is a schematic diagram of a light control device for a vehicle in a second position of the vehicle provided by some embodiments of the present disclosure;

FIG. 5 is a schematic diagram illustrating a light traversing principle of a light control device for a vehicle during vehicles travelling towards each other provided by some embodiments of the present disclosure;

FIG. 6 is a schematic structural diagram of a controllable polarizer in some embodiments of the present disclosure; and

FIG. 7 is a schematic diagram of a control relationship of a light control device for a vehicle provided by some embodiments of the present disclosure.

### DETAILED DESCRIPTION

The present invention provides a vehicle, and a light control device and a light control method thereof, so as to reduce the intensity of light entering the sight of a driver in the vehicle, therefore the probability that a visual blind spot occurs to a driver during the travelling of the vehicle due to the interference light ahead is reduced.

In order to illustrate the vehicle, and the light control device and the light control method thereof provided by the embodiments of the present disclosure further, the detailed description will be given below with reference to the accompanying drawings.

The light control device provided by the embodiments of the present disclosure is used for a vehicle, and the vehicle may be an ordinary car, a bus, or any of other vehicles.

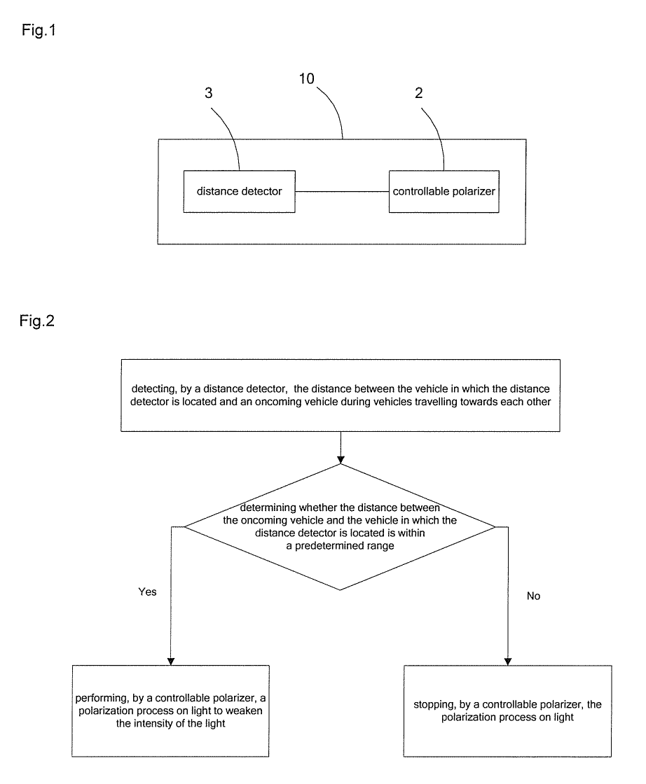

Referring to FIG. 1 and FIG. 2, the light control device 10 for a vehicle includes a controllable polarizer 2 and a distance detector 3, and a signal output end of the distance detector 3 is connected to a control end of the controllable polarizer 2. The distance detector 3 is configured to detect a distance between the vehicle in which the distance detector 3 is located and an interference light source. The controllable polarizer 2 is configured to perform a polarization process on light to weaken the intensity of the light when the distance between the interference light source and the vehicle is within a predetermined range; and configured to stop the polarization process on the light when the distance between the interference light source and the vehicle is outside the predetermined range. The interference light source refers to a light source outside the vehicle in which the distance detector 3 is located which may affect the safe driving of a driver, including but not limiting to the high beam in a vehicle which travels towards the vehicle in which the distance detector 3 is located.

In the following, taking that the high beam of another vehicle is the interference light source when two vehicles travelling towards each other as an example, steps of the light control device 10 for a vehicle controlling light will be described with reference to FIG. 1 and FIG. 2.

Step 1: detecting, by the distance detector 3, during vehicles travelling towards each other, the distance between the vehicle in which the distance detector 3 is located and another vehicle (referred as an oncoming vehicle) travelling towards the vehicle in which the distance detector 3 is located.

Step 2: determining whether the distance between the oncoming vehicle and the vehicle in which the distance detector 3 is located is within a predetermined range.

Step 3: performing, by the controllable polarizer 2, a polarization process on light to weaken the intensity of the light when the distance between the oncoming vehicle and the vehicle in which the distance detector 3 is located is within the predetermined range, then to make sure that the intensity of light entering the sight of a driver within the predetermined range is weakened; and stopping, by the controllable polarizer 2, the polarization process on the light when the distance between the oncoming vehicle and the vehicle in which the distance detector 3 is located is outside the predetermined range.

In the light control device for a vehicle provided by the above embodiments of the present disclosure, a signal output end of the distance detector 3 is connected to a control end of the controllable polarizer 2, so that the distance detector 3 can be used to detect whether the distance between the oncoming vehicle and the vehicle in which the distance detector 3 is located during vehicles travelling towards each other. When the distance between the vehicle and the oncoming vehicle in which the distance detector 3 is located is within the predetermined range, so that the intensity of the light can be weakened by the controllable polarizer 2 within the predetermined range, thereby the probability that a visual blind spot occurs to the driver within the predetermined range is reduced.

When vehicles meeting on a road at night, it is generally required the driver to switch the high beam to the low beam within 150 meters from the oncoming vehicle. Therefore, the light control device provided by the embodiments weakens the intensity of the light by the controllable polarizer 2, when the distance between the oncoming vehicle and the vehicle in which the distance detector 3 is located is less than 150 meters, otherwise the polarization process of the light is stopped. If the predetermined range described above is expressed as greater than or equal to zero and less than or equal to a predetermined distance A, the predetermined distance A may be any value within the range of greater than or equal to 145 meters and less than or equal to 180 meters. For example, the above predetermined range may be 0 to 180 m, or 0 to 150 m, or 0 to 145 m.

Detecting the distance between the oncoming vehicle and the vehicle in which the distance detector 3 is located during vehicles travelling towards each other by the distance detector 3, and performing the polarization process on the light to weaken the intensity of the light by the controllable polarizer 2; and stopping the polarization process on the light by the controllable polarizer 2 when the distance between the oncoming vehicle and the vehicle in which the distance detector 3 is located is outside the predetermined range, so that the unnecessary energy loss of the controllable polarizer 2 can also be sufficiently reduced.

In some embodiments of the present disclosure, the above distance detector 3 may be a GPS positioning system, a Beidou positioning system, an infrared detector or an ultrasonic detector, and of course, may also be any other distance detector 3 capable of achieving a distance detection, and there is no limit to the distance detector. In addition, the predetermined range can be set according to some practical needs, and it is not always the same.

In addition, in some embodiments of the present disclosure, there are various positions on the vehicle 1 at which the controllable polarizer 2 can be located. The effect of the polarization process performed on the light emitted from the headlight of the vehicle 1, by the controllable polarizer 2 when it is located at different positions on the vehicle 1, will be exemplified in the following.

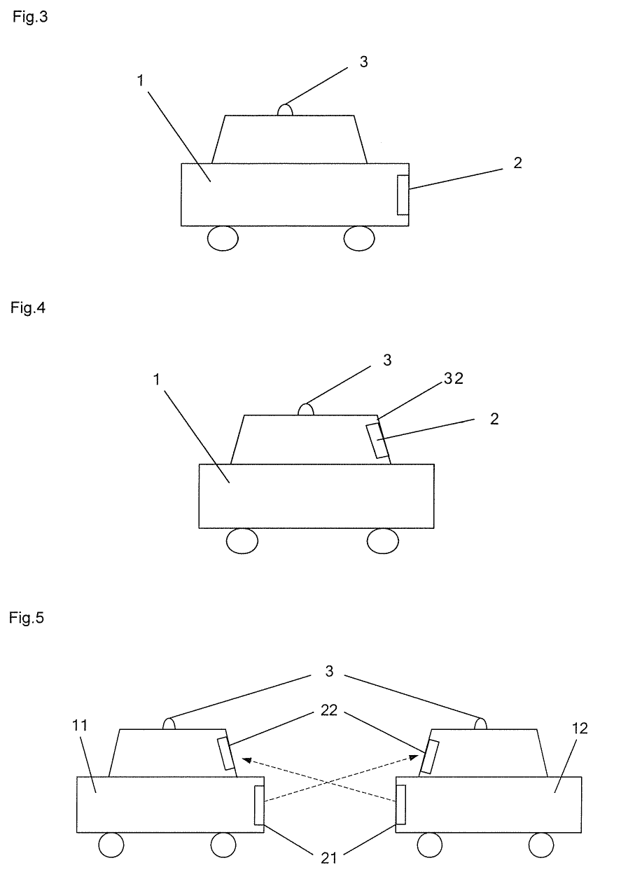

The first position: the controllable polarizer 2 is located on a light-emitting surface of a headlight of the vehicle 1 as shown in FIG. 3. And at this time, performing the polarization process on the light by the controllable polarizer 2 includes: performing the polarization process on the light emitted from the headlight of the vehicle 1 by the controllable polarizer 2, to weaken the intensity of the light emitted from the headlight of the vehicle 1. When performing the polarization process on the light by the controllable polarizer 2, a part of the light emitted from the headlight of the vehicle 1 is reflected or absorbed by the controllable polarizer 2, and only a remaining part of the light emitted from the headlight of the vehicle 1 passes through the controllable polarizer 2, so that the intensity of light entering a vision field of a driver in the oncoming vehicle can be weakened to a certain extent.

Stopping the polarization process on the light by the controllable polarizer 2 includes: stopping the polarization process on the light emitted from the headlight of the vehicle 1 by the.

The second position: the controllable polarizer 2 is located on the windshield of the vehicle as shown in FIG. 4. And at this time, performing the polarization process on the light by the controllable polarizer 2 includes: performing the polarization process on the light emitted to the windshield of the vehicle 1 by the controllable polarizer 2, to weaken the intensity of the light emitted to the windshield of the first vehicle 1; In this way, the intensity of light entering a field of a driver in the vehicle 1 can be weakened; moreover, since the controllable polarizer 2 on the windshield performs the polarization process only on the light passing through the windshield, it does not affect the intensity of the light emitted from the headlight of the vehicle in which the controllable polarizer 2 is located.

Stopping the polarization process on the light by the controllable polarizer 2 includes: stopping the polarization process on the light emitted to the windshield of the vehicle by the controllable polarizer 2.

It should be explained that the light emitted to the windshield 32 of the vehicle 1 may be light emitted from the vehicle 1 itself, or may be light emitted from the oncoming vehicle during vehicles travelling towards each other, of course, may be light emitted from any other light source. This greatly increases the scope of application of the light control device for a vehicle provided by the embodiments.

In some embodiments of the present disclosure, the number of the controllable polarizer can also be determined according to practical needs. For example, as shown in FIG. 5, the number of the controllable polarizer is two, a first controllable polarizer 21 and a second controllable polarizer 22. The first controllable polarizer 21 is located on the light-emitting surface of the headlight of the vehicle, and the second controllable polarizer 22 is located on the windshield of the vehicle. The first controllable polarizer 21 and the second controllable polarizer 22 are located in the same vehicle, and in this case, the first controllable polarizer 21 and the second controllable polarizer 22 are controlled by the same controller.

The polarization process performed on the light by the controllable polarizer 2 is carried out during vehicles travelling towards each other. For the convenience of the following description, two vehicles travelling towards each other are expressed as a first vehicle 11 and a second vehicle 12. Any one of the first vehicle 11 and the second vehicle 12 is provided with the first controllable polarizer 21 and the second controllable polarizer 22. The positions where the first controllable polarizer 21 and the second controllable polarizer 22 are located can refer to the previous description.

From the perspective of the first vehicle 11, the light emitted from the headlight of the first vehicle 11 is polarized into a polarized light by the first controllable polarizer 21 in the first vehicle 11, and a part of the light emitted from the headlight of the first vehicle 11 is reflected or absorbed by the first controllable polarizer 21, while a remaining part of the light emitted from the headlight of the first vehicle 11 passes through the first controllable polarizer 21 of the first vehicle 11; and when the remaining part of the light is directed towards the windshield of the second vehicle 12, the second controllable polarizer 22 of the second vehicle 12 performs the polarization process on the remaining part of the light, so that the light emitted from the headlight of the first vehicle 11 can be further reduced, thereby the intensity of light entering a vision field of a driver in the second vehicle 12 can be weakened.

From the perspective of the second vehicle 12, the light emitted from the headlight of the second vehicle 12 is polarized into a polarized light by the first controllable polarizer 21 in the second vehicle 12, and a part of the light emitted from the headlight of the second vehicle 12 is reflected or absorbed by the first controllable polarizer 21, while a remaining part of the light emitted from the headlight of the second vehicle 12 passes through the first controllable polarizer 21 of the second vehicle 12; and when the remaining part of the light is directed towards the windshield of the first vehicle 11, the second controllable polarizer 22 of the first vehicle 11 performs the polarization process on the remaining part of the light, so that the light emitted from the headlight of the second vehicle 12 can be further reduced, thereby the intensity of light entering a vision field of a driver in the first vehicle 11 can be weakened.

In order to further improve the reduction efficiency of the intensity of light, the polarization direction of the first controllable polarizer 21 and that of the second controllable polarizer 22 may be defined to be different, so that the second controllable polarizer 22 of the second vehicle 12 can further absorb and reflect the light emitted from the headlight of the first vehicle 11 after the light emitted from the headlight of the first vehicle 11 is polarized by the first controllable polarizer 21 of the first vehicle 11 when the first vehicle 11 and the second vehicle 12 are travelling towards each other, so as to reduce the intensity of the light entering the vision field of the driver in the second vehicle 12. Similarly, the light emitted from the headlight of the second vehicle 12 can pass through the second controllable polarizer 22 of first vehicle 11 to further reduce the intensity of the light, before entering the vision field of the driver in the first vehicle 11.

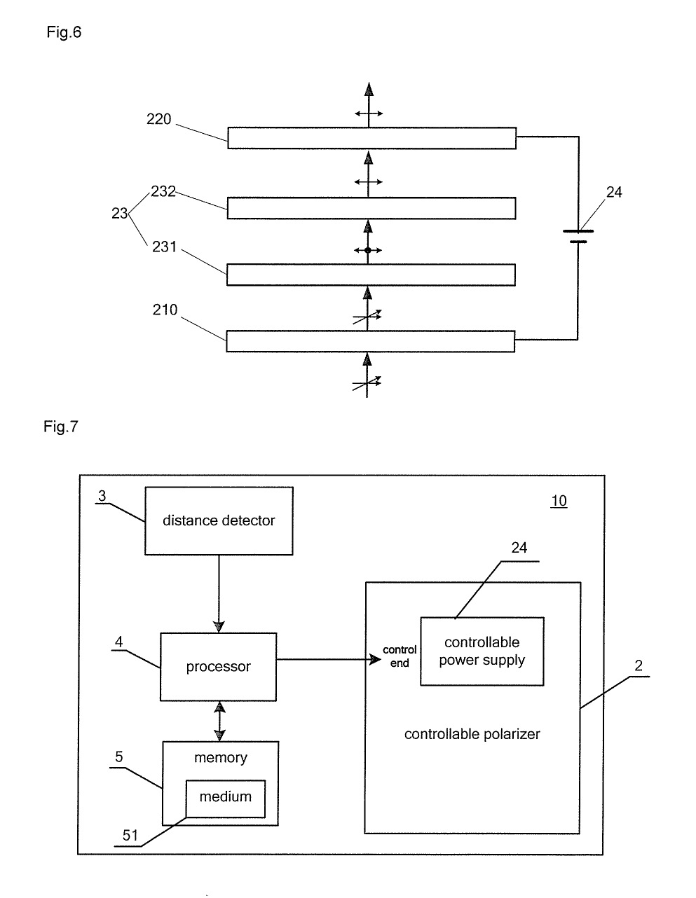

As shown in FIG. 6, the controllable polarizer 2 not only includes a controllable power supply 24, but also includes a first conductive layer 210, a second conductive layer 220, and a polarizing material layer 23 located between the first conductive layer 210 and the second conductive layer 220. And output ends of the controllable power supply 24 are connected to the first conductive layer 210 and the second conductive layer 220, respectively. The signal output end of the distance detector 3 is connected to a control end of the controllable power supply 24.

During vehicles travelling towards each other, the distance detector 3 detects the distance between the oncoming vehicle and the vehicle in which the distance detector 3 is located in real time, and when the distance between the oncoming vehicle and the vehicle in which the distance detector 3 is located is within the predetermined range, a signal generated by the distance detector 3 is transmitted to the control end of the controllable power supply 24 through the signal output end, so that the controllable power supply 24 enters a working state. At this time, the controllable power supply 24 applies voltages to the first conductive layer 210 and the second conductive layer 220, so that the polarizing material layer 23 is in an electric field formed by the first conductive layer 210 and the second conductive layer 220. In this way, it is ensured that the polarizing material layer 23 enters a working state to perform the polarization process on the light passing through the polarizing material layer 23.

In some embodiments of the present disclosure, both the first conductive layer 210 and the second conductive layer 220 are made of an indium tin oxide thin film or a carbon nanotube conductive coating, so as to improve the conductive property of the first conductive layer 210 and the second conductive layer 220, and this enables the polarizing material layer 23 located between the first conductive layer 210 and the second conductive layer 220 to enter the working state quickly; furthermore, since the first conductive layer 210 and the second conductive layer 220 are made of the indium tin oxide thin film or the carbon nanotube conductive coating, both the first conductive layer 210 and the second conductive layer 220 have a good light transmitting property. In this way, it can be ensured that the intensity of the light is weakened controllably, since the intensity of the light can only be weakened by the polarization property of the polarizing material layer 23 when the polarizing material layer 23 performs the polarization process on the light.

Optionally, the polarizing material layer 23 includes an electro-optical crystal sublayer 231 and an optical material sublayer 232 sequentially disposed along a direction of light transmission; that is to say, regardless whether the first controllable polarizer 21 or the second controllable polarizer 22 performs the polarization process on the light, the light always firstly passes through the electro-optical crystal sublayer 231 and is divided into two linear polarized light beams via a birefringence process with polarization directions perpendicular to each other; then the two linear polarized light beams with polarization directions perpendicular to each other are selectively transmitted by the optical material sublayer 232 , so that one linear polarized light beam is totally reflected by the optical material sublayer 232, while another linear polarized light beam passes through the optical material sublayer 232. In this way, the intensity of the light can be weakened by using the electro-optical crystal sublayer 231 and the optical material sublayer 232.

In some embodiments of the present disclosure, the electro-optical crystal sublayer 231 is made of any one or any several materials selected from the group of potassium dihydrogen phosphate, ammonium dihydrogen phosphate, and potassium dihydrogen arsenate. In a power-on state, these crystal materials are capable of performing a birefringence process on the light, to form two linear polarized light beams with polarization directions perpendicular to each other.

Please refer to FIG. 1, the embodiments of the present disclosure further provides a vehicle. The vehicle includes the light control device for a vehicle provided by the above technical solutions. Comparing with related technologies, the beneficial effects of the vehicle provided by the embodiments of the present disclosure are the same as the beneficial effects of the light control devices for a vehicle provided by the above technical solutions, and will not be described in detail here.

Please refer to FIG. 1 and FIG. 2, the embodiments of the present disclosure further provides a light control method for a vehicle which is applied to the light control device 10 for a vehicle. The light control method for a vehicle includes steps 1-2.

Step 1, detecting, by the distance detector 3, the distance between the oncoming vehicle and the vehicle in which the distance detector 3 is located during vehicles travelling towards each other;

Step 2, performing, by the controllable polarizer 2, the polarization process on the light to weaken the intensity of the light when the distance between the oncoming vehicle and the vehicle in which the distance detector 3 is located is within a predetermined range; stopping, by the controllable polarizer 2, the polarization process on the light when the distance between the oncoming vehicle and the vehicle in which the distance detector 3 is located is outside the predetermined range.

Comparing with related technologies, the beneficial effects of the light control method for a vehicle provided by the embodiments of the present disclosure are the same as the beneficial effects of the light control device for a vehicle provided by the above technical solutions, and will not be described in detail here.

It can be understood that, between the step 1 and the step 2, a determination step is generally included to determine if the distance between the oncoming vehicle and the vehicle in which the distance detector 3 is located is within the predetermined range.

As shown in FIG. 3, the controllable polarizer 2 is located on the light-emitting surface of the headlight of the vehicle 1. At this time, performing the polarization process on the light by the controllable polarizer 2 includes: performing the polarization process on the light emitted from the headlight of the vehicle by the controllable polarizer 2, to weaken the intensity of the light emitted from the headlight of the vehicle 1; stopping the polarization process on the light by the controllable polarizer 2 includes: stopping the polarization process on the light emitted from the headlight of the vehicle 1 by the controllable polarizer 2.

As shown in FIG. 4, the controllable polarizer 2 is located on the windshield of the vehicle 1. Performing the polarization process on the light by the controllable polarizer 2 includes: performing the polarization process on the light emitted to the windshield of the vehicle 1 by the controllable polarizer 2, to weaken the intensity of the light emitted to the windshield of the vehicle; stopping the polarization process on the light by the controllable polarizer 2 includes: stopping the polarization process on the light emitted to the windshield of the vehicle 1 by the controllable polarizer 2.

While in the case that the number of the controllable polarizer is two, one of the two controllable polarizers is located on the light-emitting surface of the headlight of the vehicle 1, and another controllable polarizer is located on the windshield of the vehicle 1. The polarization directions of the two controllable polarizers are different. A step of performing the polarization process on the light by the two controllable polarizers includes:

performing the polarization process on the light emitted from the headlight of the vehicle 1 by the controllable polarizer located on the light-emitting surface of the headlight of the vehicle 1, to weaken the intensity of the light emitted from the headlight of the vehicle 1; performing the polarization process on the light emitted to the windshield of the vehicle 1 by the controllable polarizer located on the windshield of the vehicle 1, to weaken the intensity of the light emitted to the windshield of the vehicle 1.

A step of stopping the polarization process on the light by the two controllable polarizers includes: stopping the polarization process on the light emitted from the headlight of the vehicle 1 by the controllable polarizer located on the light-emitting surface of the headlight of the vehicle 1; stopping the polarization process on the light emitted to the windshield of the vehicle 1 by the controllable polarizer located on the windshield of the vehicle 1.

The beneficial effects brought to the light control method for a vehicle, by the positions where the controllable polarizers are disposed and the number of the controllable polarizers which is two, can refer to the previous description, and will not be described in detail herein.

Please refer to FIG. 6, the controllable polarizer 2 includes a controllable power supply 24, a first conductive layer 210, a second conductive layer 220, and a polarizing material layer 23 located between the first conductive layer 210 and the second conductive layer 220. Output ends of the controllable power supply 24 are connected to the first conductive layer 210 and the second conductive layer 220, respectively; and a signal output end of the distance detector 3 is connected to a control end of the controllable power supply 24. The polarizing material layer 23 includes an electro-optical crystal sublayer 231 and an optical material sublayer 232 sequentially disposed along the direction of light transmission. At this time, performing the polarization processing on the light by the controllable polarizer 2 includes:

the controllable power supply 24 applies voltages to the first conductive layer 210 and the second conductive layer 220, so that the electro-optical crystal sublayer 23 is in the electric field formed by the first conductive layer 210 and the second conductive layer 220;

the electro-optical crystal sublayer 231 performs a birefringence process on light, so that the light is divided into two linear polarized light beams with polarization directions perpendicular to each other;

when heading to the optical material sublayer 232, one of the two linear polarized light beams is totally reflected, and another linear polarized light beam passes through the optical material sublayer 232, so that an emitted light with a single polarization direction is obtained.

It can be understood through the process of performing the polarization process on the light by the controllable polarizer 2 described above that, the light is divided into two linear polarized light beams with the polarization directions perpendicular to each other when passing through the electro-optical crystal sublayer 231, and only one of the two linear polarized light beams passes through the optical material sublayer 232 when they head to the optical material sublayer 232. Therefore, the embodiments of the present disclosure can achieve the purpose to weaken the intensity of the light through the cooperation of the electro-optical crystal sublayer 231 and the optical material sublayer 232.

It will be noted that, the refractive indexes of the two linear polarized light beams perpendicular to each other are recorded as n and n′, respectively, and the refractive index of the optical material sublayer 232 is recorded as n0, wherein n<n0<n′; only the formula of n<n0<n′ is satisfied, then the linear polarized light beam having the refractive index n is totally reflected by the optical material sublayer 232 and the linear polarized light beam having the refractive index n′ is transmitted through the optical material sublayer 232.

The embodiments of the disclosure further provide a non-transitory computer readable storage medium. Computer instructions that are executed by a processor are stored on the non-transitory computer readable storage medium, wherein, the computer instructions are configured to perform the above light control method for a vehicle while the processor is running.

The embodiments of the disclosure further provide a computer program product. The computer program product includes instructions. When the instructions are running on a computer, the light control method for a vehicle described above is performed by the computer.

The embodiments of the disclosure further provide a computer program. When the computer program is loaded onto the processor and then executed by the processor, the light control method for a vehicle as described above is implemented.

The embodiments of the disclosure further provides a light control device 10 for a vehicle, as shown in FIG. 7, including a distance detector 3, a processor 4, a memory 5 and a controllable polarizer 2. The memory 5 includes a medium 51 on which computer instructions that are executed by the processor are stored, wherein, the computer instructions are configured to perform the above light control method for a vehicle while the processor is running. The processor 4 is configured to perform a determination step after receiving a detection result from the distance detector 3, i.e., determining whether the distance between a first vehicle and a second vehicle is within a predetermined range. In a case that the detection result of the distance detector 3 is that the distance is within the predetermined range, a control signal for turning on a controllable power supply 24 of the controllable polarizer 2 is generated and input to a control end of the controllable power supply 24. Then the controllable power supply 24 enters a working state, and the controllable polarizer 2 begins to perform the polarization process on the light. The processor 4 is also configured to, in a case that the detection result of the distance detector 3 is that the distance is outside the predetermined range, generate a control signal for turning off the controllable power supply 24 of the controllable polarizer 2, and input the control signal to the control end of the controllable power supply 24. The controllable power supply 24 is thus turned off, and the controllable polarizer 2 stops the polarization process on the light.

If there are a plurality of controllable polarizers in the light control device for a vehicle provided by the present disclosure, the operation process of the light control device and the beneficial effects brought by the light control device can be referred to the previous description and will not be described in detail herein.

The steps of the method or algorithm described in the embodiments of the present disclosure may be implemented by a processor via executing software instructions. The software instructions may consist of corresponding software modules. The software modules may be stored in a random access memory (RAM), a flash memory, a read only memory (ROM), an erasable programmable ROM (EPROM), an electrically EPROM (EEPROM), a register, a hard disk, a mobile hard disk, a CD-ROM, or any other form of storage medium known in the art. An exemplary storage medium is coupled to the processor such that the processor can read information from the storage medium and write information into the storage medium. The processor may be a component having a logic operation capability and/or a program execution capability, such as a central processing unit (CPU), a field programmable logic array (FPGA), a microcontroller unit (MCU), an application specific integrated circuit (ASIC), and the like.

Those skilled in the art should be aware that, in the above one or more examples, the functions described herein may be implemented in hardware, software, firmware, or any combination thereof. If implemented in software, the functions may be stored on a computer-readable medium or transmitted as one or more instructions or codes over a computer-readable medium. The computer-readable medium includes both computer storage medium may be any available medium that can be accessed by a general purpose or special purpose computer and computer communication medium including any medium that facilitates the transfer of a computer program from one place to another. In the embodiments of the present disclosure, when a communication of data, information, etc. occurs, the communication can be directly or indirectly performed through a network connection. For example, the network may include a wireless network, a wired network, and/or any combination of the wireless network and the wired network. The network may include a local area network, an Internet, a telecommunication network, an internet of things based on the internet and/or the telecommunication network, and/or any combination of the above networks. The wired network may use a transmission medium such as a twisted pair, a coaxial cable, or an optical fiber and so on. The wireless network, for example, may use a communication mode such as a 3G/4G/5G mobile communication network, Bluetooth, Zigbee, or WiFi and the like.

In the above description of the embodiments, specific features, structures, materials, or characteristics may be combined in any suitable manner in any one or more embodiments or examples.

The above is merely the specific embodiments of the present disclosure, but the scope of the disclosure is not limited thereto. The changes and modifications that can be easily made by any person skilled in the art within the technical scope are also covered within the scope of the disclosure. Therefore, the scope of the present disclosure should be based on the scope of the claims.

1. A light control device for a vehicle, comprising a distance detector and at least one controllable polarizer, wherein, a signal output end of the distance detector is connected to a control end of each of the at least one controllable polarizer;
the distance detector is configured to detect the distance between the first vehicle in which the distance detector is located and an interference light source,
the at least one controllable polarizer is configured to perform a polarization process on light to weaken the intensity of the light when the distance between the interference light source and the first vehicle is within a predetermined range, and stop the polarization process on the light when the distance between the interference light source and the first vehicle is outside the predeteiniined range.

2. The light control device according to claim 1, wherein, the at least one controllable polarizer is located on a light-emitting surface of a headlight of the first vehicle.

3. The light control device according to claim 1, wherein, the at least one controllable polarizer is located on a windshield of the first vehicle.

4. The light control device according to claim 1, wherein, the at least one controllable polarizer comprises two controllable polarizers, one of the two controllable polarizers is located on a light-emitting surface of a headlight of the first vehicle, and another is located on a windshield of the first vehicle; the polarization directions of the two controllable polarizers are different.

5. The light control device according to claim 1, wherein, each of the at least one controllable polarizer comprises a controllable power supply, a first conductive layer, a second conductive layer, and a polarizing material layer located between the first conductive layer and the second conductive layer; output ends of the controllable power supply are connected to the first conductive layer and the second conductive layer, respectively; and the signal output end of the distance detector is connected to a control end of the controllable power supply.

6. The light control device according to claim 5, wherein, both the first conductive layer and the second conductive layer are made of an indium tin oxide material.

7. The light control device according to claim 5, wherein, the polarizing material layer comprises an electro-optical crystal sublayer and an optical material sublayer sequentially disposed along a direction of light transmission.

8. The light control device according to claim 1, wherein, the interference light source comprises a high beam located on a second vehicle travelling towards the first vehicle.

9. A vehicle, comprising the light control device according to claim 1.

10. A light control method for a vehicle, applied to the light control device according to claim 1, comprising:
detecting, by a distance detector, the distance between a first vehicle in which the distance detector is located and an interference light source;
performing, by at least one controllable polarizer, a polarization process on light to weaken the intensity of the light when the distance between the interference light source and the first vehicle is within a predetermined range; stopping, by the at least one controllable polarizer, the polarization process on the light when the distance between the interference light source and the first vehicle is outside the predetermined range.

11. The light control method for a vehicle according to claim 10, wherein, the at least one controllable polarizer is located on the light-emitting surface of a headlight of the first vehicle;
performing the polarization process on the light by the at least one controllable polarizer comprises: performing the polarization process on the light emitted from the headlight of the first vehicle by the at least one controllable polarizer, to weaken the intensity of the light emitted from the headlight of the first vehicle;
stopping the polarization process on the light by the at least one controllable polarizer comprises: stopping the polarization process on the light emitted from the headlight of the first vehicle by the at least one controllable polarizer.

12. The light control method for a vehicle according to claim 10, wherein, the at least one controllable polarizer is located on a windshield of the first vehicle;
performing the polarization process on the light by the at least one controllable polarizer comprises: performing the polarization process on the light emitted to the windshield of the first vehicle by the at least one controllable polarizer, to weaken the intensity of the light emitted to the windshield of the first vehicle;
stopping the polarization process on the light by the at least one controllable polarizer comprises: stopping the polarization process on the light emitted to the windshield of the first vehicle by the at least one controllable polarizer.

13. The light control method for a vehicle according to claim 10, wherein, the at least one controllable polarizer comprises two controllable polarizers, one of the two controllable polarizers is located on a light-emitting surface of a headlight of the first vehicle, and another controllable polarizer is located on a windshield of the first vehicle; the polarization directions of the two controllable polarizers are different;
performing the polarization process on the light by the two controllable polarizers comprises: performing the polarization process on the light emitted from the headlight of the first vehicle by the controllable polarizer located on the light-emitting surface of the headlight of the first vehicle, to weaken the intensity of the light emitted from the headlight of the first vehicle; performing the polarization process on the light emitted to the windshield of the first vehicle by the controllable polarizer located on the windshield of the first vehicle, to weaken the intensity of the light emitted to the windshield of the first vehicle; stopping the polarization process on the light by the two controllable polarizers comprises: stopping the polarization process on the light emitted from the headlight of the first vehicle by the controllable polarizer located on the light-emitting surface of the headlight of the first vehicle; stopping the polarization process on the light emitted to the windshield of the first vehicle by the controllable polarizer located on the windshield of the first vehicle.

14. The light control method for a vehicle according to claim 10, wherein, each of the at least one controllable polarizer comprises a controllable power supply, a first conductive layer, a second conductive layer, and a polarizing material layer between the first conductive layer and the second conductive layer; output ends of the controllable power supply are connected to the first conductive layer and the second conductive layer, respectively; and the signal output end of the distance detector is connected to a control end of the controllable power supply; the polarizing material layer comprises an electro-optical crystal sublayer and an optical material sublayer sequentially disposed along the direction of light transmission;
performing the polarization process on the light by the at least one controllable polarizer comprises:
for each controllable polarizer of the at least one controllable polarizer, applying voltages by its controllable power supply to its first conductive layer and its second conductive layer, so that its electro-optical crystal sublayer is in an electric field formed by the first conductive layer and the second conductive layer;
performing a birefringence process on light by the electro-optical crystal sublayer, so that the light is divided into two linear polarized light beams with polarization directions perpendicular to each other;
when heading to its optical material sublayer, one of the two linear polarized light beams is totally reflected by the optical material sublayer, and another linear polarized light beam passes through the optical material sublayer, so that an emitted light with a single polarization direction is obtained.

15. A light control device for a vehicle, comprising a processor, a distance detector, and at least one controllable polarizer; wherein,
the distance detector is configured to detect the distance between a first vehicle in which the distance detector is located and an interference light source;
the processor is configured to determine whether the distance between the interference light source and the first vehicle is within a predetermined range when a detection result of the distance detector is received, and control the at least one controllable polarizer to perform a polarization process on light to weaken the intensity of the light in a case that the distance between the interference light source and the first vehicle is within the predeteiiiiined range, and control the at least one controllable polarizer to stop the polarization process on the light in a case that the distance between the interference light source and the first vehicle is outside the predetermined range.

16. A non-transitory computer readable storage medium, on which computer instructions that are executed by a processor are stored, wherein, the computer instructions are configured to perform the light control method for a vehicle according to claim 10 while the processor is running.

17. A computer program product comprising instructions which are running on a computer, wherein the light control method for a vehicle according to claim 10 is performed by the computer.
